(19) United States
(12) Patent Application Publication
(10) Pub. No.: US 2012/0089406 A1
(43) Pub. Date: Apr. 12, 2012

(54) SYSTEM AND METHOD FOR GROUPING TRIP ITINERARIES

(76) Inventors: Steven Ladd Huffman, San Francisco, CA (US); Adam Julian Goldstein, San Francisco, CA (US)

(21) Appl. No.: 13/152,042

(22) Filed: Jun. 2, 2011

Related U.S. Application Data
(60) Provisional application No. 61/477,488, filed on Apr. 20, 2011.
(60) Provisional application No. 61/477,495, filed on Apr. 20, 2011.
(60) Provisional application No. 61/391,997, filed on Oct. 11, 2010.

(51) Int. Cl. G06Q 10/00

(52) U.S. Cl. 705/1.1

(57) ABSTRACT

A system, a computer-readable storage medium including instructions, and a computer-implemented method to group trip itineraries is described. A plurality of trip itineraries is obtained, wherein the plurality of trip itineraries is obtained in response to a search query received from a user of a computer system. A dominating trip itinerary and a dominated trip itinerary from the plurality of trip itineraries is identified, wherein the dominating trip itinerary satisfies predetermined domination criteria with respect to the dominated trip itinerary. A user interface to be displayed on the computer system is generated, wherein the user interface is generated to present details of the dominating trip itinerary to the exclusion of details of the dominated trip itinerary.

### RELATED APPLICATIONS

This application claims priority under 35 U.S.C. §119 to U.S. Provisional Patent Application No. 61/477,488 filed 20 Apr. 2011, entitled “System and Method for Grouping Trip Itineraries,” by inventors Steven Ladd Huffman and Adam Julian Goldstein; this application also claims priority under 35 U.S.C. §119 to U.S. Provisional Patent Application No. 61/477,495 filed 20 Apr. 2011, entitled “System and Method for Filtering Trip Itineraries”, by inventors Adam Julian Goldstein and Steven Ladd Huffman; this application also claims priority under 35 U.S.C. §119 to U.S. Provisional Patent Application No. 61/391,997 filed 11 Oct. 2010, entitled “System and Method for Identifying Flight Itineraries,” by inventors Adam Julian Goldstein and Steven Ladd Huffman; this application also claims priority under 35 U.S.C. §120 to U.S. Design patent application No. 29/383,565 filed 19 Jan. 2011, entitled “User Interface for a Display,” by inventors Adam Julian Goldstein and Steven Ladd Huffman; this application also claims priority under 35 U.S.C. §120 to U.S. Design patent application No. 29/383,568 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application No. 29/383,570 filed 19 Jan. 2011, entitled “User Interface for a Display,” by inventors Adam Julian Goldstein and Steven Ladd Huffman; this application also claims priority under 35 U.S.C. §120 to U.S. Design patent application No. 29/383,574 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application No. 29/383,575 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application No. 29/383,576 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application No. 29/383,578 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application No. 29/383,579 filed 19 Jan. 2011, entitled “Transitional User Interface for a Display,” by inventors Adam Julian Goldstein and Steven Ladd Huffman; which applications are incorporated by reference herein in their entirety.

### TECHNICAL FIELD

The disclosed embodiments relate generally to grouping trip itineraries.

### BACKGROUND

Travel websites provide tools for travelers to search for and display trip itineraries (e.g., transportation and lodging options). These tools typically generate a user interface that displays trip itineraries satisfying a search query submitted by a traveler. However, the same trip itineraries may be displayed multiple times under different names or descriptions. Furthermore, less desirable trip itineraries may be displayed. These trip itineraries clutter the results and make it more difficult for the traveler to identify a desired trip itinerary.

### BRIEF DESCRIPTION OF THE DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating a networked system, according to some embodiments.

FIG. 2 is a block diagram illustrating a server, according to some embodiments.

FIG. 3 is a block diagram illustrating a client computer system, according to some embodiments.

FIG. 4 is a block diagram illustrating an aggregator computer system, according to some embodiments.

FIG. 5 is a block diagram illustrating a server-side trip itinerary data structure, according to some embodiments.

FIG. 6 is a block diagram illustrating a server-side routing data structure, according to some embodiments.

FIG. 7 is a block diagram illustrating a server-side leg data structure, according to some embodiments.

FIG. 8 is a block diagram illustrating a search data structure, according to some embodiments.

FIG. 9 is a block diagram illustrating a client-side routing data structure, according to some embodiments.

FIG. 10 is a block diagram illustrating a client-side trip itinerary data structure, according to some embodiments.

FIG. 11 is a block diagram illustrating a client-side routing time data structure, according to some embodiments.

FIG. 12 is a flowchart of a method for grouping trip itineraries, according to some embodiments.

FIG. 13 is a flowchart of a method for identifying a dominating trip itinerary and a dominated trip itinerary, according to some embodiments.

FIG. 14 is a flowchart of a method for generating a list of dominated trip itineraries for a respective trip itinerary, according to some embodiments.

FIG. 15 is a flowchart of a method for removing trip itineraries in a list of dominated trip itineraries for a respective trip itinerary when at least one other trip itinerary satisfies predetermined domination criteria with respect to the respective trip itinerary, according to some embodiments.

FIG. 16A illustrates a process of identifying dominated and dominating trip itineraries, according to some embodiments.

FIG. 16B continues the process illustrated in FIG. 16A, according to some embodiments.

FIG. 16C continues the process illustrated in FIG. 16B, according to some embodiments.

FIG. 17A is a block diagram illustrating an exemplary user interface for grouping trip itineraries, according to some embodiments.

FIG. 17B is a block diagram illustrating the exemplary user interface of FIG. 17A after expanding grouped trip itineraries, according to some embodiments.

FIG. 18 is a block diagram of a machine, according to some embodiments.

### DESCRIPTION OF EMBODIMENTS

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

Note that the term “trip itinerary” is used in this specification to refer to one or more routes to one or more destinations that are associated with particular dates and/or times. A route may be traversed by an airplane, a train, a bus, a car, or any other mode of transportation. A destination may include a hotel, a restaurant, a point-of-interest (e.g., museum, landmark), or any other place to which a traveler may desire to travel. A route may include one or more legs between intermediate destinations. For example, a trip itinerary may include two routes: (1) a route from point A to point B and (2) a route from point B to point A (e.g., a round-trip trip itinerary). Route (1) may include two legs: (a) a leg from point A to point C and (2) a leg from point C to point B. Route (2) may include one leg from point B to point A.

Also note that although the following description refers to flights, the embodiments described herein may be applied to any mode of transportation including, but not limited to, airplane, train, bus, car, bicycle, foot, and the like. Furthermore, the embodiments described herein may be applied to displaying itineraries for hotel reservations, car rentals, restaurant reservations, and any type of reservation that involves a time and/or a date.

As discussed above, search tools on existing travel websites typically present all trip itineraries that satisfy a search query. In doing so, the same trip itinerary may be displayed multiple times. For example, a flight operated by one airline may be marketed by multiple airlines. Each of these airlines may use their own airline code and flight number. Accordingly, the same flight may be displayed multiple times as different flights. Moreover, similar and less desirable trip itineraries may also be displayed. For example, consider (1) a first flight that is priced at $300, leaves SFO at 9:00 AM and arrives at LAX at 10:00 AM, and has an on-time record of 89%, (2) a second flight that is also priced at $300, leaves SFO at 9:00 AM and arrives at LAX at 10:00 AM, and has an on-time record of 25%, and (3) a third flight that is priced at $350 and leaves SFO at 9:00 AM and arrives at LAX at 10:00 AM, and has an on-time record of 89%. In this example, the first flight may be more desirable than the second flight because the first flight has a higher on-time record than the second flight. The first flight may also be more desirable than the third flight because the first flight is less expensive than the third flight. Displaying all of these flights in the user interface may make it more difficult for the traveler to identify a desired trip itinerary.

The embodiments described herein provide techniques for grouping trip itineraries to reduce the number of redundant, worse, or similar trip itineraries displayed in the user interface.

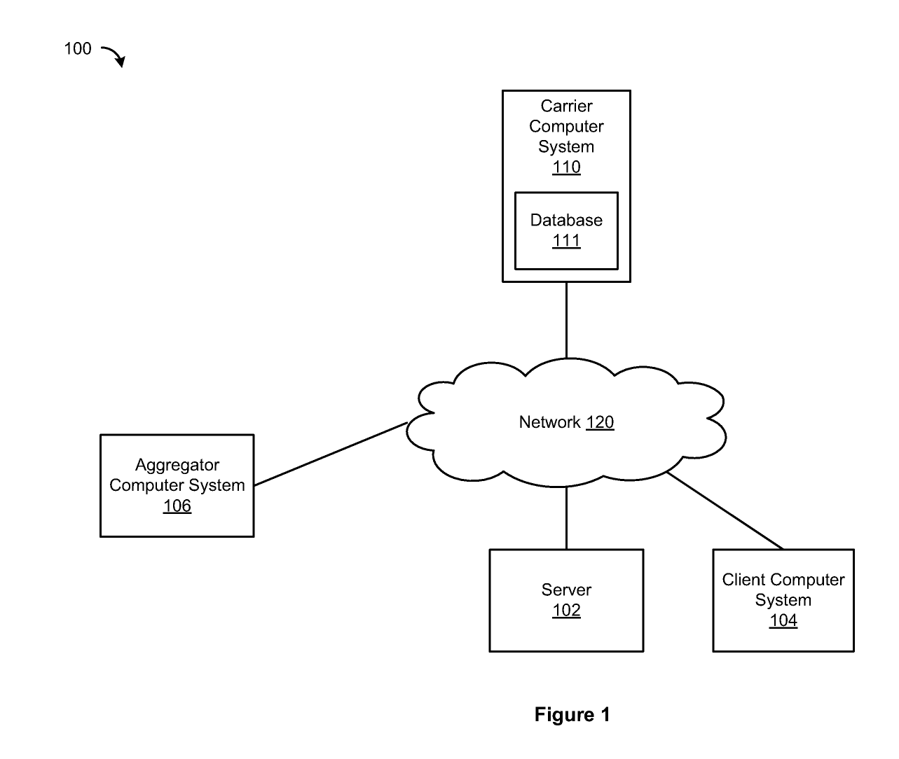

FIG. 1 is a block diagram illustrating a networked system 100, according to some embodiments. The networked system 100 includes a server 102, a client computer system 104 (e.g., a computer system of a traveler), an aggregator computer system 106, and a carrier computer system 110. Note that although only one computer system is illustrated for each of the server 102, the client computer system 104, the aggregator computer system 106, and the carrier computer system 110, the embodiments described herein may be applied to multiple instances of these computer systems. For example, the server 102 may include a plurality of distributed servers (e.g., geographically distributed servers, distributed servers within a data center) where each server handles a portion of the computations (e.g., search requests). Similarly, the aggregator computer system 106 may be one of a plurality of distributed computer systems operated by a single aggregator (e.g., an entity that sells aggregated trip itineraries) and the carrier computer system 110 may be one of a plurality of distributed computer systems operated by a single carrier (e.g., a single airline, an airline alliance). Moreover, multiple aggregators and/or carriers may also operate in the networked system 100. Furthermore, the client computer system 104 may be one of a plurality of client computer systems, each of which is operated by a traveler. Note that although the server 102, the aggregator computer system 106, and the carrier computer system 110 are illustrated as separate computer systems, two or more of the server 102, the aggregator computer system 106, and the carrier computer system 110 may be combined together into a single computer system. For example, the server 102 and the aggregator computer system 110 may be a single computer system.

In some embodiments, the server 102, the client computer system 104, the aggregator computer system 106, and the carrier computer system 110 are coupled to each other via network 120. Network 120 can generally include any type of wired or wireless communication channel capable of coupling together computing nodes (e.g., the server 102, the client computer system 104, the carrier computer system 110). This includes, but is not limited to, a local area network (LAN), a wide area network (WAN), or a combination of networks. In some embodiments, network 120 includes the Internet. In some embodiments, network 120 includes at least one private network (e.g., a virtual private network, a private physical network). In these embodiments, one or more of the server 102, the client computer system 104, the aggregator computer system 106, and the carrier computer system 110, are coupled to each other via the private network.

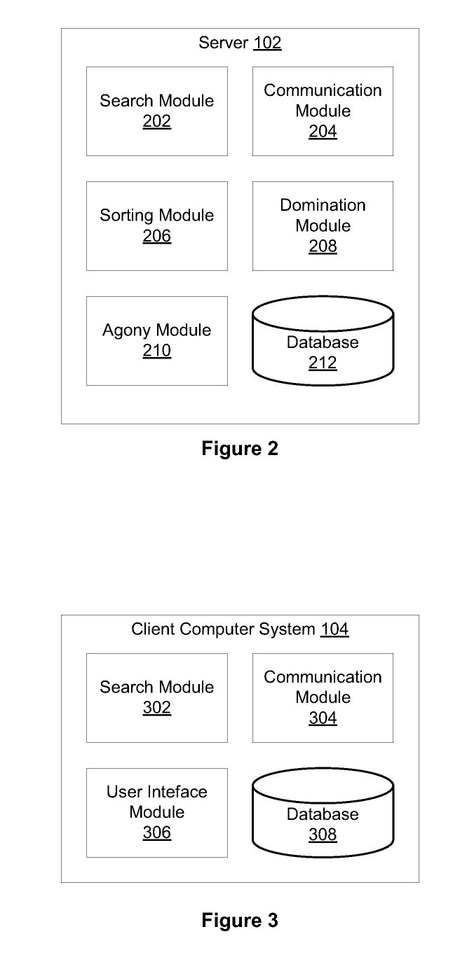

In some embodiments, the server 102 is configured to execute search queries to identify trip itineraries that satisfy search parameters received from a traveler using the client computer system 104. FIG. 2 is a block diagram illustrating the server 102, according to some embodiments. The server 102 includes a search module 202, a communication module 204, a sorting module 206, a domination module 208, an agony module 210, and a database 212. The search module 202 is configured to execute search queries to identify trip itineraries that satisfy search parameters received from the traveler using the client computer system 104. The communication module 204 is configured to receive data and/or commands (e.g., trip itineraries from the carrier computer system 110 and/or the aggregator computer system 106, search queries from the client computer system 104) via network 120 and to transmit data (e.g., trip itineraries to the client computer system 104) via network 120. The sorting module 206 is configured to generate presorted lists of trip itineraries based on predetermined criteria (e.g., by price, by date/time, by agony score). The benefit of generating the presorted lists of trip itineraries is that the client computer system 104 does not need to perform these computations, therefore freeing up computational resources on the client computer system 104. The domination module 208 is configured to determine the trip itineraries that are substantially similar to other trip itineraries and as a result are to be grouped together. For example, the substantially similar trip itineraries may be trip itineraries that have the same departure point (e.g., departure airport), the same arrival point (e.g., arrival airport), similar departure time, and similar arrival time. Typically, the substantially similar trip itineraries include trip itineraries that are deemed better than others as determined by the characteristics of the trip itineraries (e.g., the departure point, the arrival point, the departure time, the arrival time, price). The domination module 208 is described in more detail below. The agony module 210 is configured to generate an agony score for each trip itinerary based at least in part on the search parameters received from the traveler, traveler preferences, and/or a desirableness of the features of each trip itinerary. In some embodiments, the database 212 includes data relating to trip itineraries (e.g., received from the carrier computer system 110, the aggregator computer system 106). In some embodiments, the database 212 includes profile information for the traveler (e.g., name, credit card information, preferred carriers, preferred departure point).

In some embodiments, the server 102 periodically obtains updated data relating to trip itineraries from the carrier computer system 110 and/or the aggregator computer system 106. For example, the server 102 may obtain updated data indicating the status of trip itineraries (e.g., whether the trip itineraries are still available, the seats that are available). In these embodiments, the server 102 updates the database 212 using updated data relating to the trip itineraries.

FIG. 3 is a block diagram illustrating the client computer system 104, according to some embodiments. The client computer system 104 includes a search module 302, a communication module 304, a user interface module 306, and a database 308. The search module 302 is configured to generate search queries based on search parameters provided by a traveler using the client computer system 104, receive trip itineraries from the server 102 in response to the search queries, and display the trip itineraries in a user interface of the client computer system 104. The search module 302 is described in more detail in co-pending application U.S. patent application Ser. No. ______, entitled “System and Method for Filtering Trip Itineraries”, filed ______ by inventors Adam J. Goldstein and Steven L. Huffman (Attorney Docket No. 3283.004US1). The communication module 304 is configured to transmit data and/or commands (e.g., search queries to the server 102) via network 120 and receive data and/or commands (e.g., trip itineraries from the server 102) via network 120. In some embodiments, the search module 302 includes executable code received from the server 102. For example, the executable code may be code (e.g., Java, Javascript, HTML) executable within a web browser of the client computer system 104 to implement the functionality of the search module 302 as described herein. The user interface module 306 is configured to receive data and/or commands related to the display of objects in a display device of the client computer system 104. For example, the search module 302 may send data and/or commands to user interface module 306 to display trip itineraries in the display device of the client computer system 104. In some embodiments, the database 308 includes data relating to trip itineraries (e.g., received from the server 102). In some embodiments, the database 308 includes profile information for the traveler (e.g., name, credit card information, preferred carriers, preferred departure point).

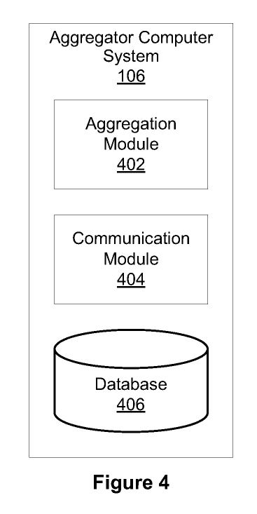

FIG. 4 is a block diagram illustrating the aggregator computer system 106, according to some embodiments. The aggregator computer system 106 includes an aggregation module 402, a communication module 404, and a database 406. The aggregation module 402 is configured to obtain trip itineraries from the carrier computer system 110. In some embodiments, the aggregation module 402 periodically obtains the trip itineraries from the carrier computer system 110. In some embodiments, the aggregation module 402 obtains the trip itineraries from the carrier computer system 110 in response to a request by the server 102 to obtain trip itineraries. The communication module 404 is configured to transmit data and/or commands (e.g., trip itineraries to the server 102) via network 120 and receive data and/or commands (e.g., trip itineraries from the carrier computer system 110) via network 120. The database 406 includes data relating to trip itineraries obtained from the carrier computer system 110.

Returning to FIG. 1, the carrier computer system 110 is configured to respond to requests from the server 102 and/or the aggregator computer system 106 for data relating to trip itineraries. In some embodiments, the trip itineraries are stored in database 111.

Note that the databases 111, 212, 308, and 406 may include any type of system for storing data in non-volatile storage. This includes, but is not limited to, systems based upon magnetic, optical, and magneto-optical storage devices, as well as storage devices based on flash memory and/or battery-backed up memory. In some embodiments, the databases 111, 212, 308, and 406 are distributed database (e.g., geographically distributed and/or distributed within a data center). In some embodiments, the databases 111, 212, 308, and 406 are relational databases. In some embodiments, the databases 111, 212, 308, and 406 are key-value stores.

The following discussion illustrates a typical process involving the networked system 100. A traveler using the client computer system 104 submits a search query including search parameters for trip itineraries to the server 102. In some embodiments, the search parameters include one or more of a departure point (e.g., departure city, departure airport, departure station), an arrival point (e.g., arrival city, arrival airport, arrival station), a departure date (or date range), a departure time (or time range), an arrival date (or date range), an arrival time (or time range), a cabin preference, a number of passengers, and preferred carriers. Note that some of the search parameters may be optional. For example, a departure point and an arrival point may be required, but the departure date, the departure time, the arrival date, the arrival time, the cabin preference, and the preferred carriers may be optional search parameters.

The server 102 then executes the search query to identify trip itineraries that satisfy the search parameters received from the client computer system 104. The server 102 may query the database 212 of the server 102 to identify trip itineraries stored in the database 212 that satisfy the search parameters. Alternatively or additionally, the server 102 may query the carrier computer system 110 and/or the aggregator computer system 106 to identify trip itineraries that satisfy the search parameters. The server 102 then transmits the identified trip itineraries to the client computer system 104.

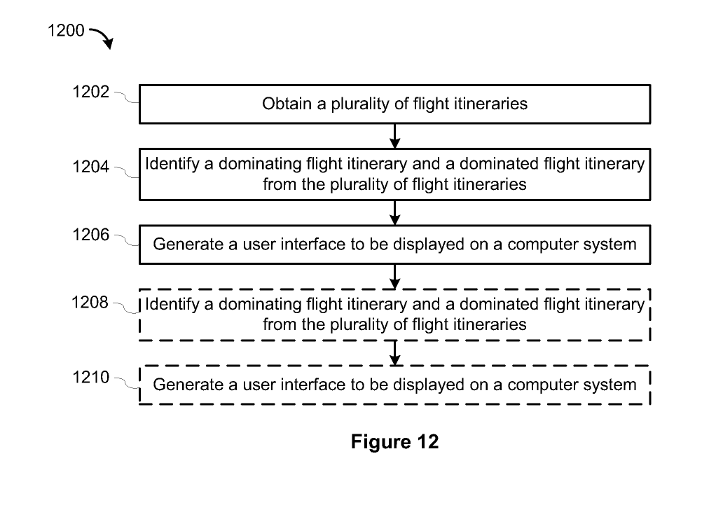

The client computer system 104 then displays the received trip itineraries in a user interface (e.g., a web browser) on the display device of the client computer system 104. In some embodiments, the client computer system 104 displays the trip itineraries on a time graph in the user interface. In some embodiments, the time graph includes at least one dominating flight itinerary that is displayed to the exclusion of corresponding dominated flight itineraries. These embodiments are described in more detail below with respect to FIGS. 12-17.

### Data Structures

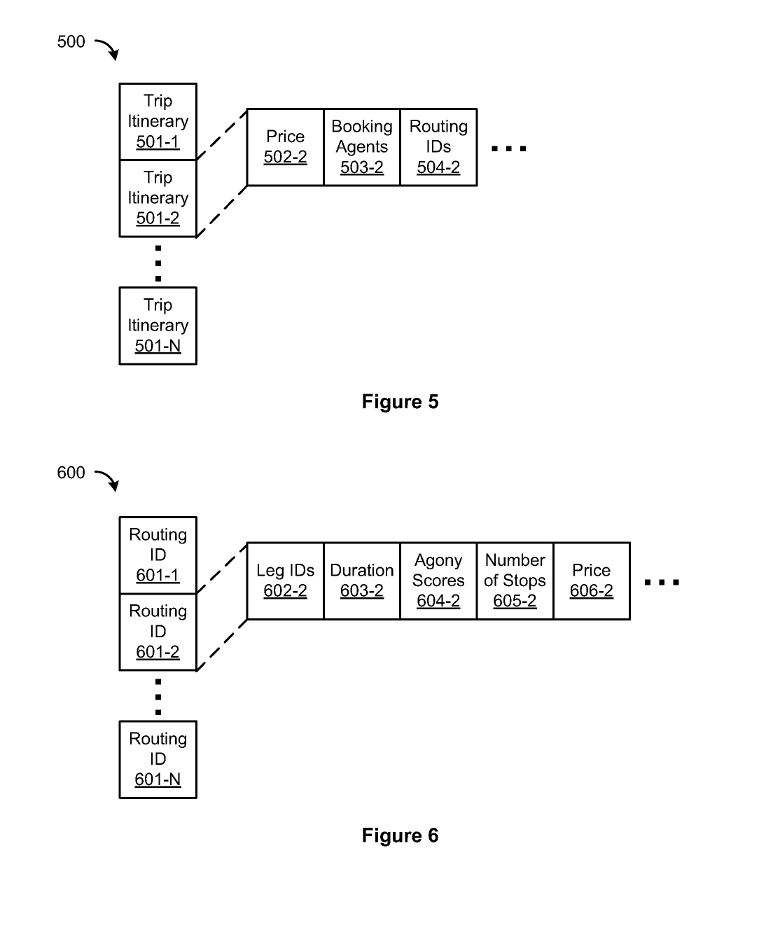

The embodiments described herein use various data structures, which are described in more detail below with respect to FIGS. 5-11.

FIG. 5 is a block diagram 500 illustrating a server-side trip itinerary data structure, according to some embodiments. The server-side trip itinerary data structure may be used by the server 102 to store trip itineraries received from the carrier computer system 110 and/or the aggregator computer system 106. Each trip itinerary 501 is associated with one or more prices 502 of the trip itinerary, one or more booking agents 503 (e.g., an online travel agent, an airline website) that are usable to book the trip itinerary, and routing IDs 504 corresponding to the routings associated with the trip itineraries. As discussed above, a routing is a collection of legs of a trip itinerary (e.g., leg 1 is SFO to PHX, leg 2 is PHX to JFK). These legs may be part of a multi-leg trip between a departure point and an arrival point and/or may be part of a round-trip itinerary. For an exemplary trip itinerary, the one or more prices 502 may be $500 and $504 corresponding to an online travel agent and an airline website (e.g., the one or more booking agents 503), and the routing IDs 504 may include a first routing ID that includes legs from SFO to PHX and PHX to JFK, and a second routing ID that includes a leg from JFK to SFO.

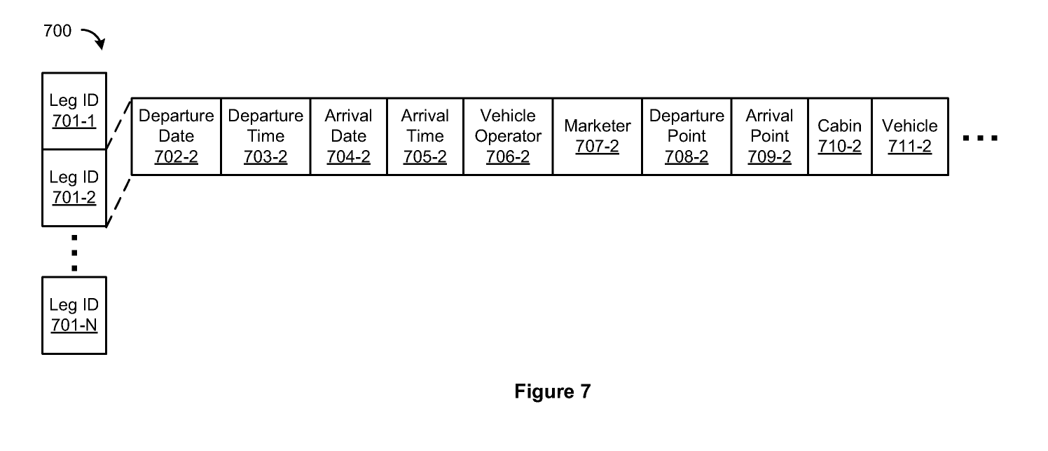

FIG. 6 is a block diagram 600 illustrating a server-side routing data structure, according to some embodiments. The server-side routing data structure is a data structure that the server 102 uses to store data relating to routings for the trip itineraries. The server-side routing data structure may be used by the server 102 to store routings received from the carrier computer system 110 and/or the aggregator computer system 106. Each routing is identified by a routing ID 601 that is associated with one or more leg IDs 602, a duration 603 of the routing (e.g., hours from the beginning to the end of the routing), agony scores 604, a number of stops 605 (e.g., layovers), and a price 606 of the routing. The one or more leg IDs 602 correspond to one or more legs of the routing, which are described in more detail below with respect to FIG. 7. The agony scores 604 indicate the extent to which the routing is desirable or not desirable. For example, a routing with a high agony score may indicate that the routing has undesirable features (e.g., likelihood of delays, has multiple stops, is expensive). In some embodiments, the agony scores 604 are based on a price of the routing, a number of stops for the routing, a duration of the routing, arrival and departure points of the routing, and a price of the routing. In some embodiments, the agony scores 604 for a routing include multiple scores. For example, the agony scores 604 for a routing may include an agony score for a typical traveler and an agony score for a traveler based on a profile of a traveler performing the search query. The agony scores 604 may also indicate the extent to which a trip itinerary is desirable or not desirable. Since a trip itinerary may include one or more routings, the trip itinerary may include a desirable routing and an undesirable routing. Thus, it may be useful to generate an agony score for the trip itinerary so that the trip itinerary is indicated to have undesirable features.

FIG. 7 is a block diagram 700 illustrating a server-side leg data structure, according to some embodiments. The server-side leg data structure is a data structure that the server 102 may use to store data relating to legs of routings received from the carrier computer system 110 and/or the aggregator computer system 106. Each leg is identified by a leg ID 701 that is associated with a departure date 702, a departure time 703, an arrival date 704, an arrival time 705, a vehicle operator 706, a marketer 707, a departure point 708 (e.g., an airport, a bus stop, a train station), an arrival point 709 (e.g., an airport, a bus stop, a train station), a cabin 710 (e.g., a cabin class), and a vehicle 711 (e.g., the vehicle type, the vehicle model). Note that the vehicle operator 706 is an entity (e.g., an airline) that operates the vehicle 711 and the marketer 707 is the entity (e.g., the airline, an airline alliance partner) that is marketing the leg (e.g., the flight). The marketer 707 and the vehicle operator 706 may be the same entity (e.g., the same airline).

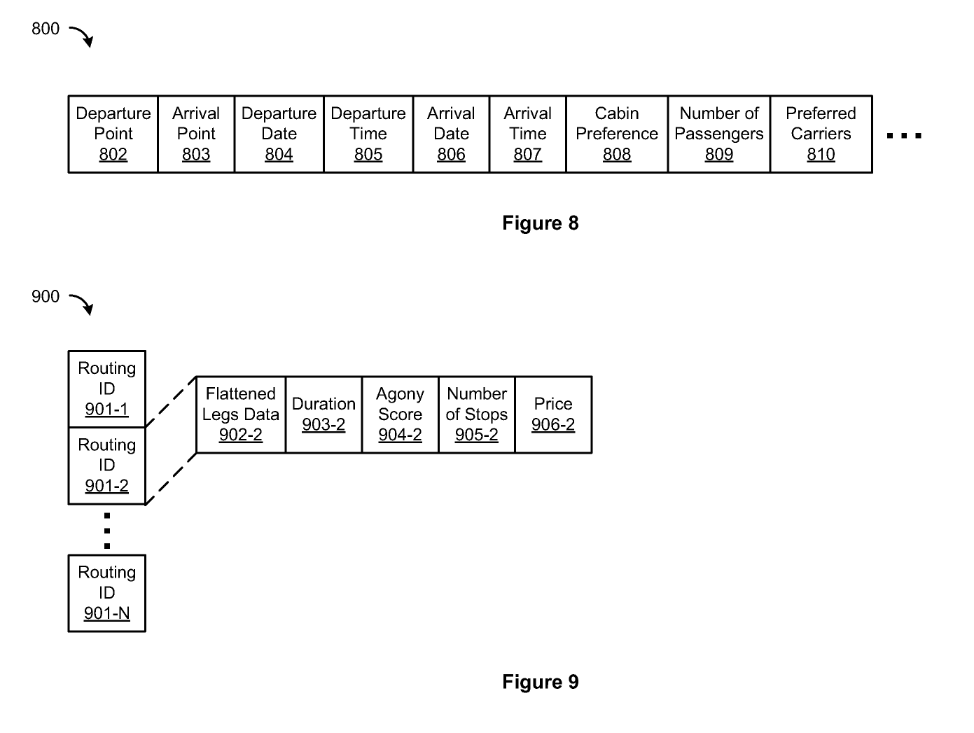

FIG. 8 is a block diagram 800 illustrating a search data structure, according to some embodiments. The search data structure is a data structure that the client computer system 104 may send to the server 102 when the client computer system 104 submits a search query to the server 102. The search data structure includes a departure point 802, an arrival point 803, and a departure date 804. The search data structure may also optionally include a departure time 805, an arrival date 806, an arrival time 807, a cabin preference 808, a number of passengers 809, and preferred carriers 810. Note that travelers may specify multiple preferred carriers 810 and/or carrier alliances, or specify that the traveler has no preference for carriers. In some embodiments, one or more of the departure point 802, the departure time 805, the arrival time 807, the cabin preference 808, the number of passengers 809, and the preferred carriers 810 are obtained from a profile for the traveler. In some embodiments, the profile of the traveler is stored on the server 102.

FIG. 9 is a block diagram 900 illustrating a client-side routing data structure, according to some embodiments. The client-side routing data structure is a data structure that is received from the server 102 and that includes a list of routings that satisfy the search query submitted by the client computer system 104. Each routing is identified by a routing ID 901 that is associated with flattened legs data 902, a duration 903, an agony score 904, a number of stops 905, and a price 906. Note that the flattened legs data 902 is the legs data from the legs data structure illustrated in FIG. 7 in flat form. In other words, the relational nature of the routings data structure and the legs data structure is removed and the data from the legs data structure is included directly in the client-side routings data structure illustrated in FIG. 9. As discussed above, the agony score 904 may include multiple agony scores (e.g., an agony score for a typical traveler, an agony score for the traveler that performed the search query).

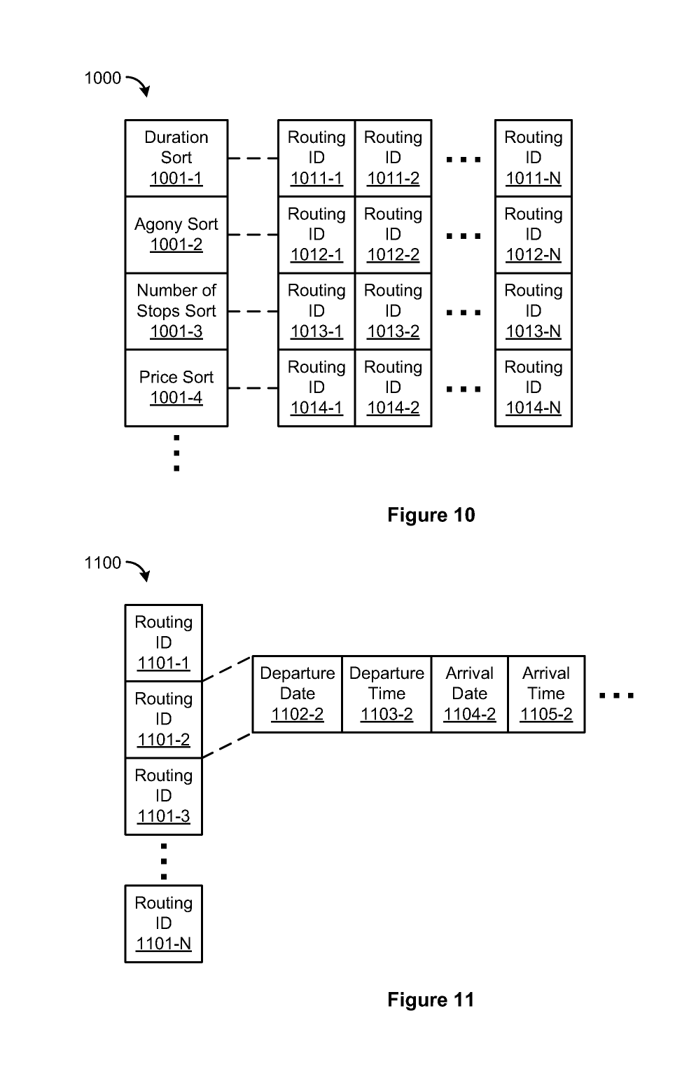

FIG. 10 is a block diagram 1000 illustrating a client-side trip itinerary data structure, according to some embodiments. The client-side trip itinerary data structure includes multiple sorts. For example, the client-side trip itinerary data structure includes a duration sort 1001-1 in which the routings (e.g., routing IDs 1011) are sorted by duration (e.g., flight duration, layover duration), an agony sort 1001-2 in which the routings (e.g., routing IDs 1012) are sorted by an agony score, a number of stops sort 1001-3 in which the routings (e.g., routing IDs 1013) are sorted by the number of stops, and a price sort 1001-4 in which the routings (e.g., routing IDs 1014) are sorted by price. In some embodiments, the server 102 generates the client-side trip itinerary data structure and sorts the routings based on sorting criteria (e.g., duration, agony score, number of stops, price). In some embodiments, the client computer system 104 receives unsorted routing data from the server 102 and sorts the routings based on the sorting criteria.

FIG. 11 is a block diagram 1100 illustrating a client-side routing time data structure, according to some embodiments. Each routing is identified by a routing ID 1101 that is associated with a departure date 1102, a departure time 1103, an arrival date 1104, and an arrival time 1105. The client-side routing time data structure may be used by the client computer system 104 to identify dates and/or times associated with routings.

### Grouping Trip Itineraries

FIG. 12 is a flowchart of a method 1200 for grouping trip itineraries, according to some embodiments. The search module 202 obtains (1202) a plurality of trip itineraries in response to a search query received from a user (e.g., a traveler) of a computer system (e.g., the client computer system 104). The search module 202 may obtain the plurality of trip itineraries from the database 111 of the carrier computer system 110, the database 406 of the aggregator computer system 106, and/or the database 212 of the server 102.

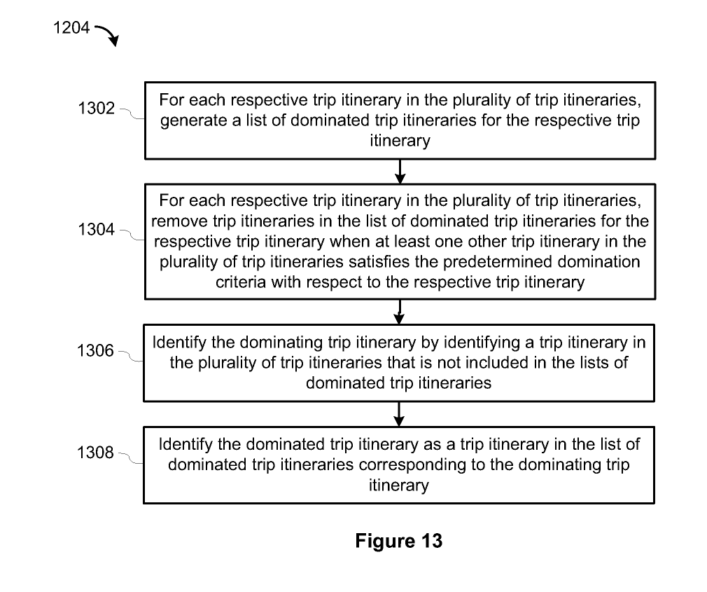

The domination module 208 identifies (1204) a dominating trip itinerary and a dominated trip itinerary from the plurality of trip itineraries, where the dominating trip itinerary satisfies predetermined domination criteria with respect to the dominated trip itinerary. Operation 1204 is described in more detail below with respect to FIG. 13.

In some embodiments, a first trip itinerary satisfies the predetermined domination criteria with respect to a second trip itinerary when each parameter in a predetermined set of parameters for the first trip itinerary are equal to or higher in value with respect to each of the corresponding parameters in the predetermined set of parameters for the second trip itinerary.

In some embodiments, the predetermined set of parameters for a trip itinerary includes one or more of a departure point, an arrival point, one or more carriers, a price of a trip itinerary, a duration of the trip itinerary, a departure time of the trip itinerary, an arrival time of the trip itinerary, and a number of stops of the trip itinerary. For a given trip itinerary, values may be assigned to at least a subset of these parameters. A value may be assigned to a parameter using any technique (e.g., a mathematical function, heuristic rules). The following exemplary guidelines may be used when assigning values to parameters: a value for a departure point is higher when the departure point is close to a starting point (e.g., the starting point/departure point specified by a traveler in the search query), a value for an arrival point is higher when the arrival point is close to the destination, a value for a carrier (e.g., an airline, an airline alliance, a train company, a bus company) is higher when the carrier is one of the preferred carriers specified by a traveler, a value for a price of a trip itinerary is higher when the price is lower, a value for a duration of the trip itinerary is higher when the duration is shorter, a value for a departure time of the trip itinerary is higher when the departure time is within a traveler-defined and/or a system-defined time range, a value for an arrival time of the trip itinerary is higher when the arrival time is within a traveler-defined and/or a system-defined time range, and a value for a number of stops of the trip itinerary is higher when the number of stops is lower.

In some embodiments, at least one parameter in the predetermined set of parameters includes a tolerance range so that when a first value of the at least one parameter for the first trip itinerary and a second value of the at least one parameter for the second trip itinerary are within the tolerance range of each other, the first trip itinerary and the second trip itinerary are deemed to be equal in value with respect to the at least one parameter. For example, if a tolerance range is +/−1 hour for a departure time, trip itineraries having departure times within +/−1 hour may be deemed to be equal in value with respect to the departure time.

In some embodiments, the dominating trip itinerary and the dominated trip itinerary have a common departure point and a common arrival point. In some embodiments, the dominating trip itinerary and the dominated trip itinerary have departure points within a first predetermined distance of each other and arrival points within a second predetermined distance of each other. For example, a search query including a departure point in the San Francisco Bay area may produce trip itineraries having a departure point of SFO, OAK, or SJC. Similarly, an arrival point in the New York City area may include an arrival point of LGA, JFK, and EWR.

In some embodiments, the dominating trip itinerary and the dominated trip itinerary have a common departure date and a common arrival date.

Attention is now directed to FIG. 13, which is a flowchart of a method for identifying (1204) the dominating trip itinerary and the dominated trip itinerary, according to some embodiments. For each respective trip itinerary in the plurality of trip itineraries, the domination module 208 generates (1302) a list of dominated trip itineraries for the respective trip itinerary. The list of dominated trip itineraries includes trip itineraries from the plurality of trip itineraries with respect to which the respective trip itinerary satisfies the predetermined domination criteria. In other words, the list of dominated trip itineraries includes trip itineraries that the respective trip itinerary dominates.

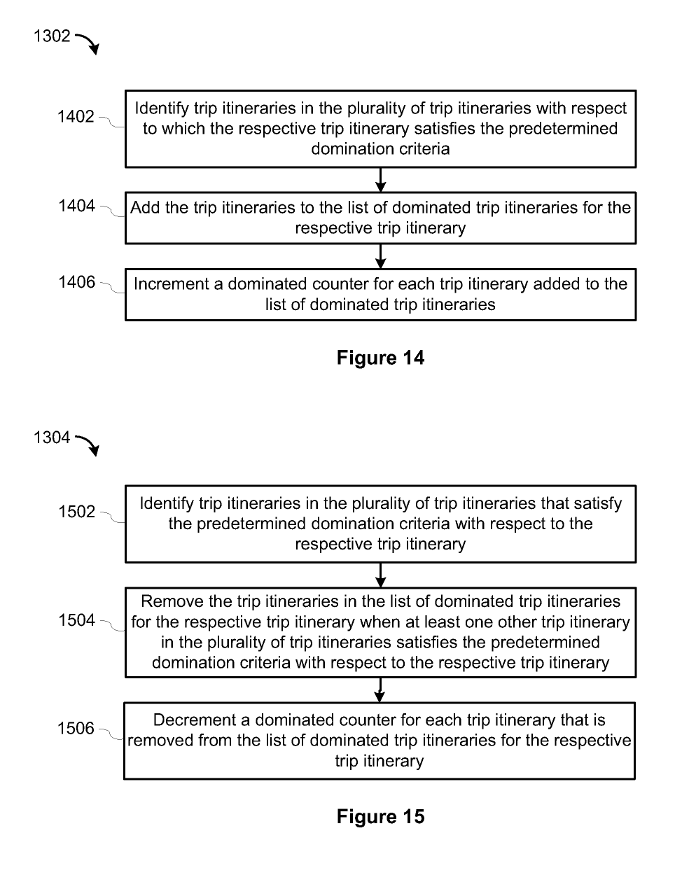

Attention is now directed to FIG. 14, which is a flowchart of a method for generating (1302) a list of dominated trip itineraries for a respective trip itinerary, according to some embodiments.

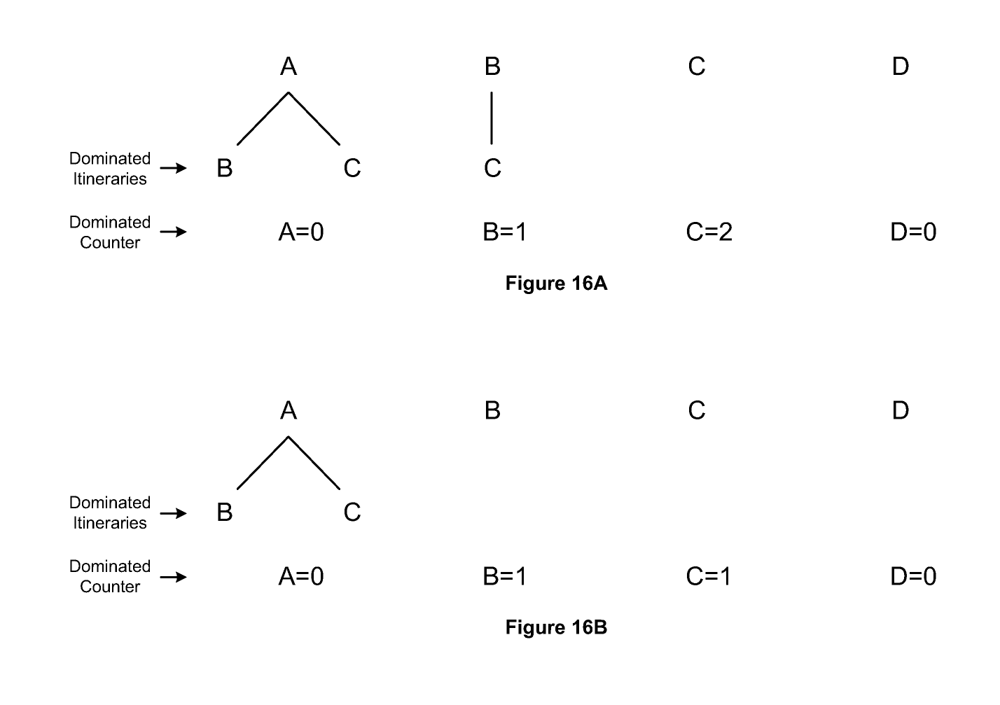

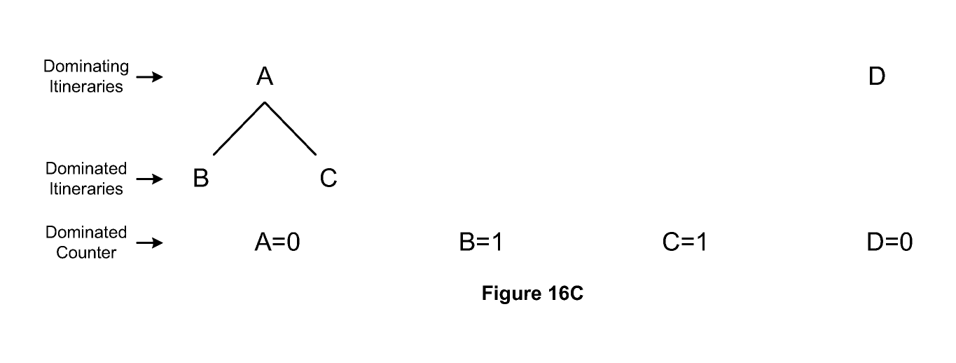

The domination module 208 identifies (1402) trip itineraries in the plurality of trip itineraries with respect to which the respective trip itinerary satisfies the predetermined domination criteria. For example, FIG. 16A includes four trip itineraries: A, B, C, and D. For trip itinerary A (e.g., the respective trip itinerary), the domination module 208 identifies that the trip itinerary A satisfies the predetermined domination criteria with respect to the trip itineraries B and C. In other words, the trip itinerary A dominates the trip itineraries B and C. The domination module 208 also identifies that the trip itinerary B satisfies the predetermined domination criteria with respect to the trip itinerary C.

The domination module 208 adds (1404) the trip itineraries to the list of dominated trip itineraries for the respective trip itinerary. Continuing the example from above, the domination module 208 adds the trip itineraries B and C to the list of dominated trip itineraries for the trip itinerary A. The domination module 208 also adds the trip itinerary C to the list of dominated trip itineraries for the trip itinerary B.

The domination module 208 increments (1406) a dominated counter for each trip itinerary added to the list of dominated trip itineraries. The dominated counter indicates a number of trip itineraries that satisfy the predetermined domination criteria with respect to the trip itinerary added to the list of dominated trip itineraries. In other words, the dominated counter indicates the number of trip itineraries that dominate the added trip itineraries. For example, referring to FIG. 16A, the dominated counter for the trip itinerary A is zero because there are no trip itineraries that satisfy the predetermined domination criteria with respect to the trip itinerary A, the dominated counter for the trip itinerary B is 1 because the trip itinerary A satisfies the predetermined domination criteria with respect to the trip itinerary B, the dominated counter for the trip itinerary C is 2 because the trip itineraries A and B satisfy the predetermined domination criteria with respect to the trip itinerary C, and the dominated counter for the trip itinerary D is zero because there are no trip itineraries that satisfy the predetermined domination criteria with respect to the trip itinerary D.

Returning to FIG. 13, for each respective trip itinerary in the plurality of trip itineraries, the domination module 208 removes (1304) trip itineraries in the list of dominated trip itineraries for the respective trip itinerary when at least one other trip itinerary in the plurality of trip itineraries satisfies the predetermined domination criteria with respect to the respective trip itinerary. In other words, if a first trip itinerary dominates a second trip itinerary and the second trip itinerary dominates a third trip itinerary, the third trip itinerary is removed from the list of dominated trip itineraries for the second trip itinerary.

Attention is now directed to FIG. 15, which is a flowchart of a method for removing (1304) trip itineraries in a list of dominated trip itineraries for a respective trip itinerary when at least one other trip itinerary satisfies predetermined domination criteria with respect to the respective trip itinerary, according to some embodiments.

The domination module 208 identifies (1502) trip itineraries in the plurality of trip itineraries that satisfy the predetermined domination criteria with respect to the respective trip itinerary. For example, in FIG. 16A, the trip itinerary A satisfies the predetermined domination criteria with respect to the trip itinerary B (e.g., the respective trip itinerary). Furthermore, the trip itineraries A and B satisfy the predetermined domination criteria with respect to the trip itinerary C.

The domination module 208 removes (1504) the trip itineraries in the list of dominated trip itineraries for the respective trip itinerary when at least one other trip itinerary in the plurality of trip itineraries satisfies the predetermined domination criteria with respect to the respective trip itinerary. Continuing the example from above, since the trip itinerary A satisfies the predetermined domination criteria with respect to the trip itinerary B, the trip itinerary C is removed from the list of dominated trip itineraries for the trip itinerary B, as illustrated in FIG. 16B.

The domination module 208 decrements (1506) a dominated counter for each trip itinerary that is removed from the list of dominated trip itineraries for the respective trip itinerary. Continuing the example from above, the domination module 208 decrements the dominated counter for the trip itinerary C by 1 because the trip itinerary C is no longer on the list of dominated trip itineraries for the trip itinerary B. In other words, the trip itinerary B is no longer deemed to dominate the trip itinerary C.

Returning to FIG. 13, the domination module 208 identifies (1306) the dominating trip itinerary by identifying a trip itinerary in the plurality of trip itineraries that is not included in the lists of dominated trip itineraries. In some embodiments, when identifying the trip itinerary in the plurality of trip itineraries that is not included in the lists of dominated trip itineraries, the domination module 208 identifies a trip itinerary in the plurality of trip itineraries for which a value of a corresponding dominated counter for the trip itinerary is zero. For example, in FIG. 16C, the dominating trip itineraries include the trip itineraries A and D because the dominated counters for the trip itineraries A and D are zero.

The domination module 208 identifies (1308) the dominated trip itinerary as a trip itinerary in the list of dominated trip itineraries corresponding to the dominating trip itinerary. For example, the dominated trip itinerary for the trip itinerary A includes the trip itineraries B and C.

Returning to FIG. 12, the domination module 208 generates (1206) a user interface to be displayed on the computer system. The user interface may be generated to present details of the dominating trip itinerary to the exclusion of details of the dominated trip itinerary. In some embodiments, the user interface is generated to present an indication of an existence of the dominated trip itinerary in association with the details of the dominating trip itinerary. In some embodiments, the indication is user-selectable to selectively reveal the details of the dominated trip itinerary within the user interface.

In some embodiments, when generating the user interface, the domination module 208 generates user interface code for the user interface and transmits the user interface code to the client computer system 104. The user interface code may include a markup language (e.g., HTML) and/or programs (e.g., scripts, browser-executable code).

In some embodiments, the user interface code includes the details of the dominating and dominated trip itineraries and logic to selectively display and hide the details of the dominated trip itinerary within the user interface of the computer system. The logic may include scripts (e.g., JavaScript scripts), browser-executable code (e.g., Java code), HTML 5 code, and the like.

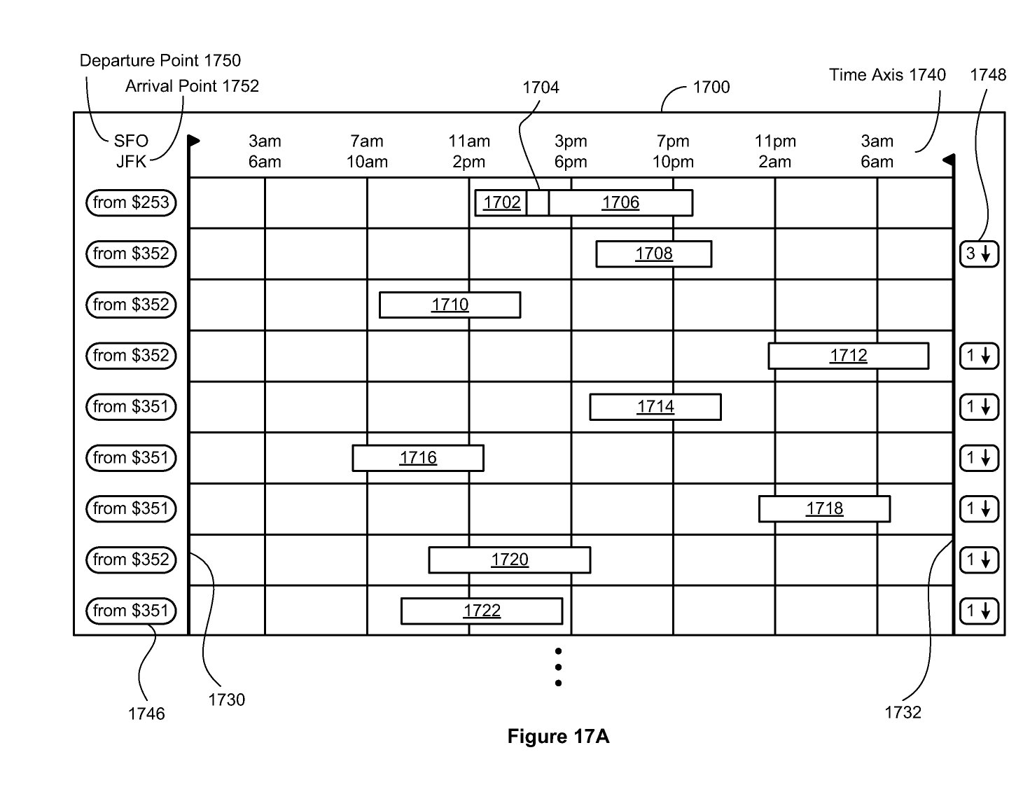

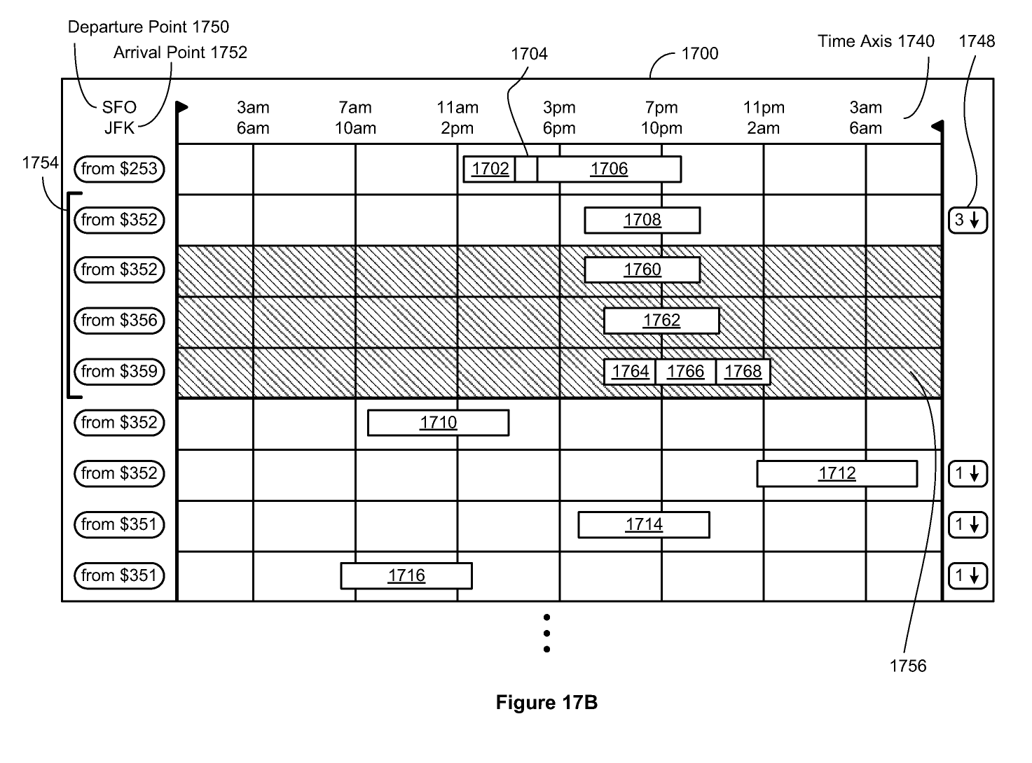

The user interface is described in more detail below with respect to FIGS. 17A and 17B, which are block diagrams illustrating an exemplary user interface for grouping trip itineraries, according to some embodiments. The user interface illustrated in FIGS. 17A and 17B is a time graph 1700 that includes a time axis 1740, which may include times, dates, days of week, and the like. The time axis 1740 may be displayed on the horizontal axis of the time graph (e.g., as illustrated in FIGS. 17A and 17B) or may be displayed on the vertical axis of the time graph 1700. In some embodiments, the time axis 1740 includes dates and/or times corresponding to the time zones of a departure point 1750 (e.g., a departure airport) and an arrival point 1752 (e.g., arrival airport). For example, the departure point 1750 may be SFO and the arrival point 1752 may be JFK. Accordingly, the time axis 1740 may include dates and/or times with respect to the Pacific Time Zone in a first row of the time axis 1740 and dates and/or times with respect to Eastern Time Zone in a second row of the time axis 1740.

As illustrated in FIGS. 17A and 17B, one or more time sliders may be displayed on the time graph 1700. For example, the time graph 1700 may include a departure time slider 1730 configured to filter out trip itineraries that depart before the time indicated by the departure time slider 1730 (e.g., trip itineraries whose departure times are to the left of the departure time slider 1730). Alternatively or additionally, the time graph 1700 may include an arrival time slider 1732 configured to filter out trip itineraries that arrive after the time indicated by the arrival time slider 1732 (e.g., trip itineraries whose arrival times are to the right of the arrival time slider 1732). In some embodiments, the departure time slider 1730 and/or the arrival time slider 1732 include a visual indicator (e.g., an arrow at the top of the departure time slider 1730 and/or the arrival time slider 1732) that indicates the time zone for which the time slider operates. For example, in FIG. 17A, the departure time slider 1730 indicates that the time zone for the departure time slider 1730 corresponds to the time zone for SFO (e.g., Pacific Time Zone) since the arrow is aligned with SFO. Similarly, the arrival time slider 1732 indicates that the time zone for the arrival time slider 1732 corresponds to the time zone for JFK (e.g., Eastern Time Zone) since the arrow is aligned with JFK.

As illustrated in FIG. 17A, trip itineraries may be represented using time bars 1702, 1704, 1706, 1708, 1710, 1712, 1714, 1716, 1718, 1720, and 1722. As discussed above, a trip itinerary may include multiple routings and a routing may include multiple legs. In FIG. 17A, one routing of a trip itinerary is displayed (e.g., SFO to JFK) where each of these routings include at least one leg of the trip itinerary. For example, a first trip itinerary includes a routing that has legs represented by the time bar 1702 (e.g., corresponding to a leg from SFO to PHX) and the time bar 1706 (e.g., corresponding to a leg from PHX to JFK). The time bar 1704 may also illustrate an the amount of time spent at a layover (e.g., at PHX). Similarly, a second trip itinerary includes a routing that has a leg represented by the time bar 1708 (e.g., corresponding to a leg from SFO to JFK). This technique for representing trip itineraries is beneficial because a traveler can easily analyze the search results to identify desirable trip itineraries.

FIG. 17A also includes a price 1746 for each of the trip itineraries. In some embodiments, when a group of trip itineraries have similar qualities (e.g., similar pricing, similar departure times and arrival times), a dominating trip itinerary is selected from the group of trip itineraries and displayed on the time graph 1700 while the other trip itineraries in the group are not displayed. The dominating trip itinerary is the trip itinerary that is deemed to be the best trip itinerary of its group. The best trip itinerary may be determined based on the price, departure times, arrival times, layover duration, and the like. The other trip itineraries in the group that are not displayed are the “dominated trip itineraries” corresponding to the dominating trip itinerary. Furthermore, a traveler may select factors that are more important than others. For example, a traveler may indicate that price should be given higher weight than departure times. To indicate the existence of the dominated trip itineraries, a domination indicator 1748 may be displayed to indicate the existence of the other trip itineraries that are similar to the dominating trip itinerary. A number of dominated trip itineraries corresponding to the dominating itinerary may be included in the domination indicator 1748 (e.g., three dominated itineraries).

In some embodiments, when a traveler clicks on (or performs an appropriate user interface action on) the domination indicator 1748, the dominated itineraries corresponding to the dominating itinerary are displayed. For example, when a traveler clicks on the domination indicator 1748, the trip itineraries represented by time bars 1760, 1762, 1764, 1766, and 1768 are displayed on the time graph 1700, as illustrated in FIG. 17B. In some embodiments, a bracket 1754 is displayed to indicate a group including the dominating trip itinerary (e.g., the trip itinerary corresponding to the time bar 1708) and corresponding dominated trip itineraries (e.g., the trip itineraries corresponding to the time bars 1760, 1762, 1764, 1766, and 1768). In some embodiments, shading 1756 is displayed to indicate the dominated trip itineraries (e.g., the trip itineraries corresponding to the time bars 1760, 1762, 1764, 1766, and 1768) corresponding to the dominating trip itinerary (e.g., the trip itinerary corresponding to the time bar 1708).

As illustrated in FIGS. 17A and 17B, trip itineraries that do not dominate other trip itineraries may be displayed without a domination indicator 1748. For example, the trip itinerary corresponding to the time bar 1710 does not include a domination indicator 1748. Alternatively, trip itineraries that do not dominate other trip itineraries may be displayed with a domination indicator 1748 whose value is zero.

Returning to FIG. 12, although operation 1204 refers to identifying a dominating trip itinerary and a dominated trip itinerary, operation 1204 may identify multiple dominating trip itineraries and corresponding dominated trip itineraries (e.g., see discussion with respect to FIGS. 13-15). Thus, in some embodiments, the domination module 208 identifies (1208) a plurality of dominating trip itineraries and corresponding dominated trip itineraries from the plurality of trip itineraries and generates (1210) the user interface to present details of the plurality of dominating trip itineraries to the exclusion of details of the corresponding dominated trip itineraries.

### Exemplary Machine

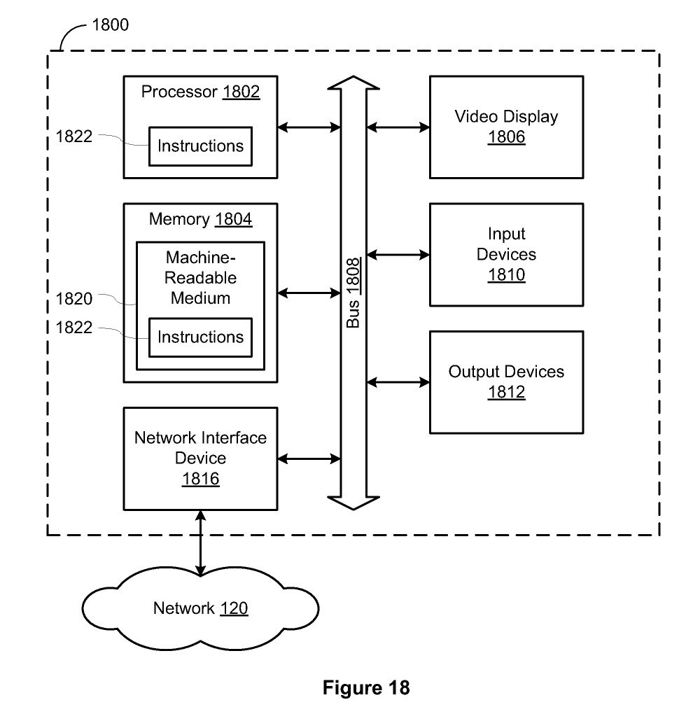

FIG. 18 depicts a block diagram of a machine in the example form of a computer system 1800 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The computer system 1800 may include, but is not limited to, a desktop computer system, a laptop computer system, a server, a mobile phone, a smart phone, a personal digital assistant (PDA), a gaming console, a portable gaming console, a set top box, a camera, a printer, a television set, or any other electronic device.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 1800 includes a processor 1802 (e.g., a central processing unit (CPU), a graphics processing unit (GPU) or both), and memory 1804, which communicate with each other via bus 1808. Memory 1804 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 1804 may optionally include one or more storage devices remotely located from the computer system 1800. The computer system 1800 may further include a video display unit 1806 (e.g., a plasma display, a liquid crystal display (LCD) or a cathode ray tube (CRT)). The computer system 1800 also includes input devices 1810 (e.g., keyboard, mouse, trackball, touchscreen display), output devices 1812 (e.g., speakers), and a network interface device 1816. The aforementioned components of the computer system 1800 may be located within a single housing or case (e.g., as depicted by the dashed lines in FIG. 18). Alternatively, a subset of the components may be located outside of the housing. For example, the video display unit 1806, the input devices 1810, and the output devices 1812 may exist outside of the housing, but be coupled to the bus 1808 via external ports or connectors accessible on the outside of the housing.

Memory 1804 includes a machine-readable medium 1820 on which is stored one or more sets of data structures and instructions 1822 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 1822 may also reside, completely or at least partially, within memory 1804 and/or within the processor 1802 during execution thereof by computer system 1800, with memory 1804 and processor 1802 also constituting machine-readable, tangible media.

The data structures and instructions 1822 may further be transmitted or received over a network 120 via network interface device 1816 utilizing any one of a number of well-known transfer protocols (e.g., HyperText Transfer Protocol (HTTP)). Network 120 can generally include any type of wired or wireless communication channel capable of coupling together computing nodes (e.g., the computer system 1800). This includes, but is not limited to, a local area network (LAN), a wide area network (WAN), or a combination of networks. In some embodiments, network 120 includes the Internet.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 1800) or one or more hardware modules of a computer system (e.g., a processor 1802 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1802 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 1802 configured using software, the processor 1802 may be configured as respective different hardware modules at different times. Software may accordingly configure a processor 1802, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1802 that are temporarily configured (e.g., by software, code, and/or instructions stored in a machine-readable medium) or permanently configured to perform the relevant operations. Whether temporarily or permanently configured, such processors 1802 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1802 or processor-implemented (or computer-implemented) modules. Similarly, at least some of the operations of a method may be governed by instructions that are stored in a computer readable storage medium and executed by one or more processors 1802 or processor-implemented (or computer-implemented) modules. The performance of certain of the operations may be distributed among the one or more processors 1802, not only residing within a single machine, but deployed across a number of machines. In some example embodiments, the processors 1802 may be located in a single location (e.g., within a home environment, an office environment or as a server farm), while in other embodiments the processors 1802 may be distributed across a number of locations.

While the embodiment(s) is (are) described with reference to various implementations and exploitations, it will be understood that these embodiments are illustrative and that the scope of the embodiment(s) is not limited to them. In general, techniques for the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A computer-implemented method to group trip itineraries, the method comprising:
obtaining a plurality of trip itineraries, the plurality of trip itineraries obtained in response to a search query received from a user of a computer system;
using at least one processor, identifying a dominating trip itinerary and a dominated trip itinerary from the plurality of trip itineraries, the dominating trip itinerary satisfying predetermined domination criteria with respect to the dominated trip itinerary; and
generating a user interface to be displayed on the computer system, the user interface being generated to present details of the dominating trip itinerary to the exclusion of details of the dominated trip itinerary.

2. The computer-implemented method of claim 1, wherein the user interface is generated to present an indication of an existence of the dominated trip itinerary in association with the details of the dominating trip itinerary.

3. The computer-implemented method of claim 2, wherein the indication is user-selectable to selectively reveal the details of the dominated trip itinerary within the user interface.

4. The computer-implemented method of claim 1, wherein generating the user interface comprises generating user interface code for the user interface at a server computer system, the user interface code to be transmitted from the server computer system to the computer system.

5. The computer-implemented method of claim 4, wherein the user interface code includes the details of the dominating and dominated trip itineraries and logic to selectively display and hide the details of the dominated trip itinerary within the user interface of the computer system.

6. The computer-implemented method of claim 1, further comprising:
identifying a plurality of dominating trip itineraries and corresponding dominated trip itineraries from the plurality of trip itineraries; and
generating the user interface to present details of the plurality of dominating trip itineraries to the exclusion of details of the corresponding dominated trip itineraries.

7. The computer-implemented method of claim 1, wherein identifying the dominating trip itinerary and the dominated trip itinerary includes:
for each respective trip itinerary in the plurality of trip itineraries, generating a list of dominated trip itineraries for the respective trip itinerary, the list of dominated trip itineraries including trip itineraries from the plurality of trip itineraries with respect to which the respective trip itinerary satisfies the predetermined domination criteria;
for each respective trip itinerary in the plurality of trip itineraries, removing trip itineraries in the list of dominated trip itineraries for the respective trip itinerary when at least one other trip itinerary in the plurality of trip itineraries satisfies the predetermined domination criteria with respect to the respective trip itinerary;
identifying the dominating trip itinerary by identifying a trip itinerary in the plurality of trip itineraries that is not included in the lists of dominated trip itineraries; and
identifying the dominated trip itinerary as a trip itinerary in the list of dominated trip itineraries corresponding to the dominating trip itinerary.

8. The computer-implemented method of claim 7, wherein generating the list of dominated trip itineraries for the respective trip itinerary includes:
identifying trip itineraries in the plurality of trip itineraries with respect to which the respective trip itinerary satisfies the predetermined domination criteria;
adding the trip itineraries to the list of dominated trip itineraries for the respective trip itinerary; and
incrementing a dominated counter for each trip itinerary added to the list of dominated trip itineraries, the dominated counter indicating a number of trip itineraries that satisfy the predetermined domination criteria with respect to the trip itinerary added to the list of dominated trip itineraries.

9. The computer-implemented method of claim 7, wherein removing the trip itineraries in the list of dominated trip itineraries for the respective trip itinerary when at least one other trip itinerary in the plurality of trip itineraries satisfies the predetermined domination criteria with respect to the respective trip itinerary includes:
identifying trip itineraries in the plurality of trip itineraries that satisfy the predetermined domination criteria with respect to the respective trip itinerary;
removing the trip itineraries in the list of dominated trip itineraries for the respective trip itinerary when at least one other trip itinerary in the plurality of trip itineraries satisfies the predetermined domination criteria with respect to the respective trip itinerary; and
decrementing a dominated counter for each trip itinerary that is removed from the list of dominated trip itineraries for the respective trip itinerary.

10. The computer-implemented method of claim 7, wherein identifying the trip itinerary in the plurality of trip itineraries that is not included in the lists of dominated trip itineraries includes identifying a trip itinerary in the plurality of trip itineraries for which a value of a corresponding dominated counter for the trip itinerary is zero.

11. The computer-implemented method of claim 1, wherein a first trip itinerary satisfies the predetermined domination criteria with respect to a second trip itinerary when each parameter in a predetermined set of parameters for the first trip itinerary are equal to or higher in value with respect to each of the corresponding parameters in the predetermined set of parameters for the second trip itinerary.

12. The computer-implemented method of claim 11, wherein the predetermined set of parameters for a trip itinerary is selected from the group consisting of:
a departure point;
an arrival point;
one or more carriers;
a price of a trip itinerary;
a duration of the trip itinerary;
a departure time of the trip itinerary;
an arrival time of the trip itinerary; and
a number of stops of the trip itinerary.

13. The computer-implemented method of claim 11, wherein at least one parameter in the predetermined set of parameters includes a tolerance range so that when a first value of the at least one parameter for the first trip itinerary and a second value of the at least one parameter for the second trip itinerary are within the tolerance range of each other, the first trip itinerary and the second trip itinerary are deemed to be equal in value.

14. The computer-implemented method of claim 1, wherein the dominating trip itinerary and the dominated trip itinerary have a common departure point and a common arrival point.

15. The computer-implemented method of claim 1, wherein the dominating trip itinerary and the dominated trip itinerary have departure points within a first predetermined distance of each other and arrival points within a second predetermined distance of each other.

16. The computer-implemented method of claim 1, wherein the dominating trip itinerary and the dominated trip itinerary have a common departure date and a common arrival date.

17. A system to group trip itineraries, comprising:
a processor-implemented search module configure to obtain a plurality of trip itineraries, the plurality of trip itineraries obtained in response to a search query received from a user of a computer system; and
a processor-implemented domination module configured to:
identify a dominating trip itinerary and a dominated trip itinerary from the plurality of trip itineraries, the dominating trip itinerary satisfying predetermined domination criteria with respect to the dominated trip itinerary; and
generate a user interface to be displayed on the computer system, the user interface being generated to present details of the dominating trip itinerary to the exclusion of details of the dominated trip itinerary.

18. The system of claim 17, wherein the user interface is generated to present an indication of an existence of the dominated trip itinerary in association with the details of the dominating trip itinerary.

19. The system of claim 18, wherein the indication is user-selectable to selectively reveal the details of the dominated trip itinerary within the user interface.

20. A computer readable storage medium storing at least one program that, when executed by at least one processor, causes the at least one processor to perform operations comprising:
obtaining a plurality of trip itineraries, the plurality of trip itineraries obtained in response to a search query received from a user of a computer system;
identifying a dominating trip itinerary and a dominated trip itinerary from the plurality of trip itineraries, the dominating trip itinerary satisfying predetermined domination criteria with respect to the dominated trip itinerary; and
generating a user interface to be displayed on the computer system, the user interface being generated to present details of the dominating trip itinerary to the exclusion of details of the dominated trip itinerary.
